(19) United States
(12) Patent Application Publication
(10) Pub. No.: US 2009/0261127 A1
(43) Pub. Date: Oct. 22, 2009

(54) FREE-FORM CONTAINER WITH FOLLOW-UP PISTON

(76) Inventor: Patrick PAN, Taipei (TW)

Correspondence Address: RABIN & Berdo, PC, 1101 14TH STREET, NW, SUITE 500, WASHINGTON, DC, 20005, US

(21) Appl. No.: 12/105,735

(22) Filed: Apr. 18, 2008

(51) Int. Cl. G01F 11/00; B67D 5/42

(52) U.S. Cl. 222/256; 222/321.7; 222/386

(57) ABSTRACT

A free-form container with follow-up piston includes a double-wall body defining an internal volume for containing a fluid, a top cover connected to an open upper end of the double-wall body, a fluid dispenser head mounted to and projected from the top cover, and a bottom cover seal an open lower end of the double-wall body. The double-wall body includes a cylindrical inner wall defining a fully round inner wall surface and a free-form outer wall integrally formed at an outer side of the inner wall. A follow-up piston is mounted in the cylindrical inner wall to face toward the fluid dispenser head. A vent hole is formed on the bottom cover to communicate an inner space of the inner wall with external air. The outer wall may have differently designed appearances to attract more consumers without affecting the operation of the follow-up piston in the cylindrical inner wall.

### FIELD OF THE INVENTION

The present invention relates to a container with follow-up piston, and more particularly to a container with follow-up piston having an integrally formed double-wall body consisting of a cylindrical inner wall and a free-form outer wall, and a bottom cover closing a common open lower end of the inner and outer walls, so that the container with follow-up piston may have differently designed appearances to highlight a contained fluid and attract more consumers.

### BACKGROUND OF THE INVENTION

In recent years, more and more cosmetic products and toiletries have been developed, manufactured, and introduced into the market. Various brands of cosmetic products and toiletries are displayed in department stores and chain stores for sale. Since these products have similar beautifying and skin-care effect, consumers frequently feel difficult to decide on which one to buy. Under this circumstance, the designs of these products' appearances tend to play an important role in attracting and/or influencing the consumers' decisions; therefore, the design of an overall appearance of cosmetic products and toiletries is a very important factor to take into consideration when selling products.

Most of the commercially available cosmetic products and toiletries are packaged in a container equipped with a push type dispensing device, which includes a saddle head and a dip tube connected to a lower side of the saddle head. The assembly of the saddle head and dip tube is then mounted to an open top of the container, which usually has a specific shape. When the saddle head is axially depressed, a pressure differential is produced in the container, bringing the cosmetic product in the form of a fluid stored in the container to move upward in the dip tube and finally flows out of the container via the saddle head.

FIG. 1 is a cutaway perspective view of a conventional container with a push type dispenser head. The container, denoted by reference numeral 20, is usually provided with a fluid dispenser head 10. The fluid dispenser head 10 basically includes a spray head 11 projected from an open top of the container 20 to expose to air. The spray head 11 is connected to and moves along with an actuator rod 12. When a user applies a downward force against the spray head 11 or releases the downward force from the spray head 11, the actuator rod 12 is brought to reciprocate vertically. A dispenser member, such as an airless pump or a valve, is extended into the container 20, so that a fluid stored in the container 20, such as perfume, cosmetics, or medicines, may be delivered to the spray head 11 via the dispenser member. The container 20 basically has a specific size and internal volume, and has a follow-up piston 22 assembled to an inner wall surface 21 of the container 20. A bottom cover 23 is assembled to an open bottom of the container 20. Please refer to FIG. 2 along with FIG. 1. The bottom cover 23 includes an upright peripheral wall 24 extended along an outer periphery of the bottom cover 23 to connect to the inner wall surface 21 of the container 20 in the manner of tight fitting. The bottom cover 23 is provided on an upper side at a central area thereof with a stop ring 25, and a vent hole 26 is formed on the bottom cover 23 between the stop ring 25 and the upright peripheral wall 24.

When a user downward pushes against the spray head 11, a low-pressure state close to a vacuum is produced in the container 20 that has the cosmetic fluid store therein. At this point, ambient atmosphere having a relatively higher pressure enters the container 20 via the vent hole 26 formed on the bottom cover 23 to form a back pressure for pushing against the follow-up piston 22. As a result, the fluid stored in the container 20 is dispensed via the spray head 11.

In the container 20 internally provided with the follow-up piston 22, the stored fluid is moved upward and dispensed mainly due to a pressure differential produced by downward pushing the spray head 11 and an upward movement of the follow-up piston 22 caused by the back pressure from the external atmosphere with higher pressure. In the above-described actuating process, the relation between the follow-up piston 22 and the inner wall surface 21 of the container 20 is just the same as that between the piston and the cylinder in an engine. It is known the piston and the cylinder in the engine must have a matching round cross section to achieve the highest possible working efficiency. That is, the piston must have a circular cross section, and the cylinder must have a circular inner wall surface. The piston and the cylinder having any other matching geometrical shapes, such as oval shape, square shape, and rectangular shape, obviously fail to provide the desired close contact between them to have the risk of leakage, and therefore could not achieve the intended function.

Due to this limitation in shape, the conventional container equipped with the follow-up piston is usually limited to a round-sectioned inner space and outer peripheral wall to match the round-sectioned follow-up piston. As a result, the conventional container with follow-up piston has a monotonous cylindrical appearance and is rarely changed. Therefore, cosmetic products and toiletries packaged with such monotonous cylindrical containers fail to attract consumers to buy them.

### SUMMARY OF THE INVENTION

It is therefore a primary object of the present invention to provide a free-form container with follow-up piston, which is no longer limited to a cylindrical appearance, but may be differently contoured to highlight a contained fluid and attract consumers.

To achieve the above and other objects, the free-form container with follow-up piston according to the present invention includes a double-wall body defining an internal volume for containing a fluid; a top cover connected to an open upper end of the double-wall body; a fluid dispenser head mounted to and projected from the top cover; and a bottom cover sealing an open lower end of the double-wall body. The double-wall body includes a cylindrical inner wall defining a fully round inner wall surface and an open bottom, and a free-form outer wall integrally formed at an outer side of the inner wall. A follow-up piston is mounted in the cylindrical inner wall to face toward the fluid dispenser head. A vent hole is formed on the bottom cover to communicate with an inner space of the inner wall.

In an operable embodiment, the cylindrical inner wall is formed near an upper part with a radially outward extended annular shoulder portion, and the free-form outer wall is downward extended from the shoulder portion to define an open bottom. The open bottom of the outer wall and the open bottom of the inner wall together form the open lower end of the container.

In an operable embodiment, the bottom cover has a shape matching a cross section of the open lower end of the container formed by the open bottoms of the inner and outer walls, so as to seal the open lower end of the container, and the vent hole formed on the bottom cover communicating the inner space defined in the inner wall with external air.

In an operable embodiment, the bottom cover is provided on an upper side with a ring portion having a size matching an inner diameter of the inner wall surface of the cylindrical inner wall, and a centered stop ring. The bottom cover is assembled to the open lower end of the container with the ring portion tightly fitted in the inner wall surface of the cylindrical inner wall and the stop ring located corresponding to and below the follow-up piston. When the bottom cover has been assembled to the container, the air vent communicates the inner space of the inner wall with external environment, and an outer periphery of the bottom cover is abutted against the open bottom of the outer wall in a tight-fit relation.

In an operable embodiment, the outer wall is integrally formed into a geometrical shape, such as an oval, a square, or a rectangular shape.

In another operable embodiment, the outer wall is integrally formed to have an ornamental appearance according to actual need.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a cutaway perspective view of a conventional container with follow-up piston;

FIG. 2 is a sectional view of a bottom cover for the conventional container shown in FIG. 1;

FIG. 3 is a cutaway perspective view of a free-form container with follow-up piston according to a preferred embodiment of the present invention;

FIG. 4 is a perspective view of a bottom cover for the container of FIG. 3;

FIG. 5 is a sectional view of the bottom cover of FIG. 4;

FIG. 6 is a phantom view of the container of FIG. 3 showing a follow-up piston in the container is located at a bottommost position before dispensing a contained fluid;

FIG. 7 is a phantom view similar to FIG. 6 but showing the follow-up piston in the container is moved upward to dispense the contained fluid;

FIG. 8 is a perspective view of an operable embodiment of the bottom cover for the container of the present invention; and

FIG. 9 is a phantom view showing another free-form container with follow-up piston according to the present invention with the bottom cover of FIG. 8 assembled to an open lower end thereof.

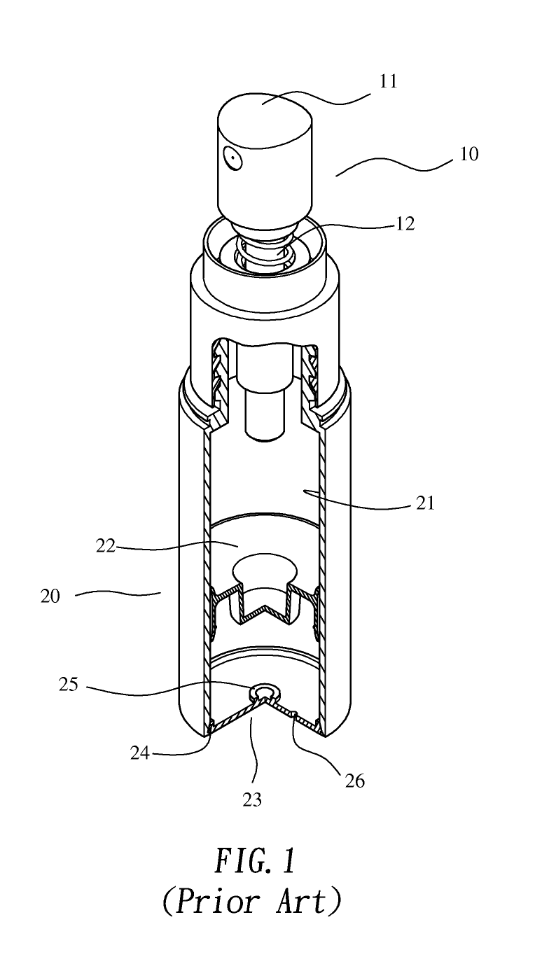

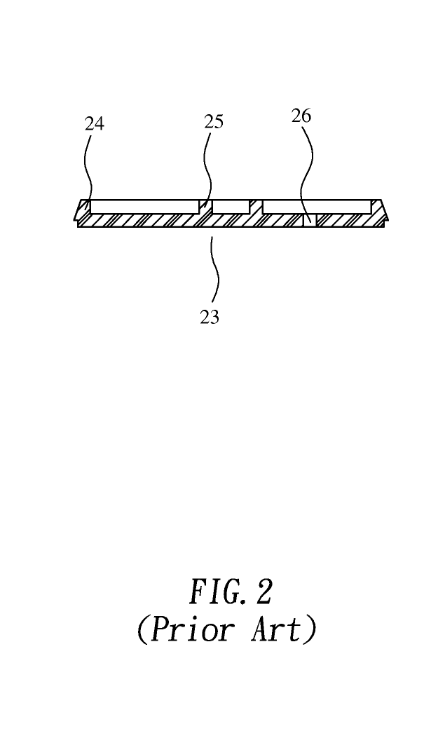

### DETAILED DESCRIPTION OF THE PREFERRED EMBODIMENTS

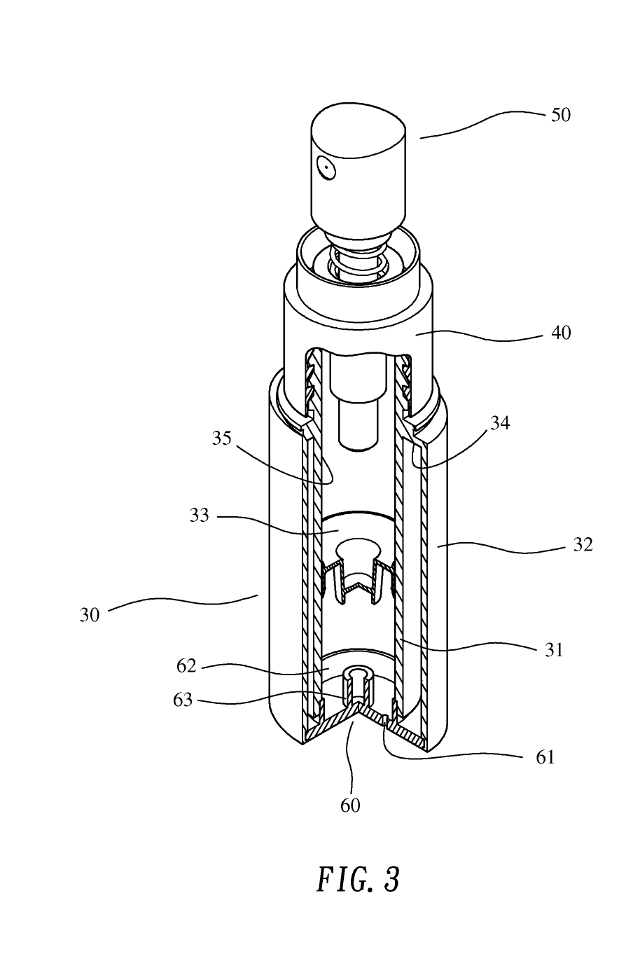

Please refer to FIG. 3 that is a cutaway perspective view of a free-form container with follow-up piston according to a preferred embodiment of the present invention. As shown, the container of the present invention is generally denoted a reference numeral 30. The container 30 defines a specific internal volume, and has a top cover 40 openably closed to an open upper end thereof. A fluid dispenser head 50 is assembled to the open upper end of the container 30 and upward projected from the top cover 40. A bottom cover 60 is fitted to an open lower end of the container 30 to seal the same.

The container 30 is an integrally formed double-wall container consisting of a cylindrical inner wall 31 and a free-form outer wall 32.

The cylindrical inner wall 31 defines a fully round inner wall surface 35 and an open bottom. A follow-up piston 33 is mounted in the round inner wall surface 35 of the cylindrical inner wall 31 to face toward the fluid dispenser head 50.

The free-form outer wall 32 is integrally formed at an outer side of the inner wall 31. In the illustrated preferred embodiment of the present invention, the free-form outer wall 32 has an oval cross section. However, it is understood the outer wall 32 is not limited to the oval shape but may be any other shapes. That is, the outer wall 32 may be formed into any shape, such as oval, square, rectangular, and other geometrical shapes. Moreover, formative arts and modeling techniques may be applied to give the outer wall 32 various ornamental appearances as desired.

In the illustrated preferred embodiment, the cylindrical inner wall 31 is formed near an upper part with a radially outward extended annular shoulder portion 34, and the free-form outer wall 32 is downward extended from the shoulder portion 34 to define an open bottom. The open bottom of the outer wall 32 and the open bottom of the inner wall 31 together form the open lower end of the container 30.

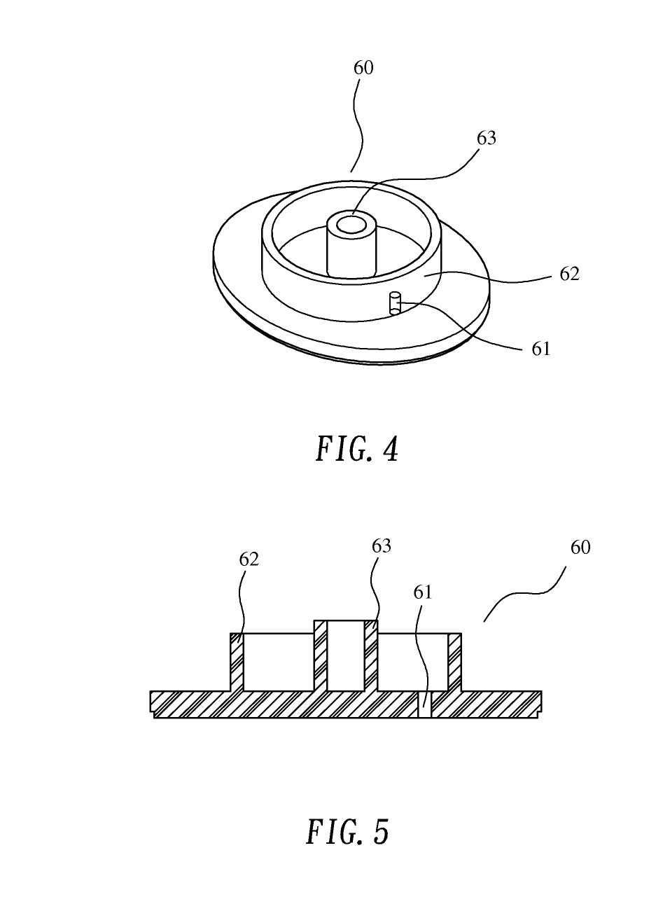

Please refer to FIGS. 4 and 5 along with FIG. 3. In the illustrated preferred embodiment, the bottom cover 60 has a contour matching the shape of the open lower end of the container 30 to seal the open lower end. A vent hole 61 is provided on the bottom cover 60 within the open bottom of the inner wall 31 to communicate an inner space defined in the inner wall 31 with external air. In the illustrated preferred embodiment, the bottom cover 60 is provided on an upper side with a ring portion 62, which has a size matching an inner diameter of the inner wall surface 35 of the cylindrical inner wall 31, and a stop ring 63 located at a central area of the bottom cover 60. The bottom cover 60 has an overall configuration matching a cross section of the free-form outer wall 32. That is, in the illustrated preferred embodiment, the bottom cover 60 is oval in shape.

Therefore, the bottom cover 60 may be assembled to the open lower end of the container 30 with the ring portion 62 tightly fitted in the inner wall surface 35 of the cylindrical inner wall 31 and the stop ring 63 located corresponding to and below the follow-up piston 33. When the bottom cover 60 has been assembled to the container 30, the air vent 61 communicates the inner space of the inner wall 31 with external environment. Meanwhile, an outer periphery of the bottom cover 60 is abutted against the open bottom of the outer wall 32 in a tight-fit relation.

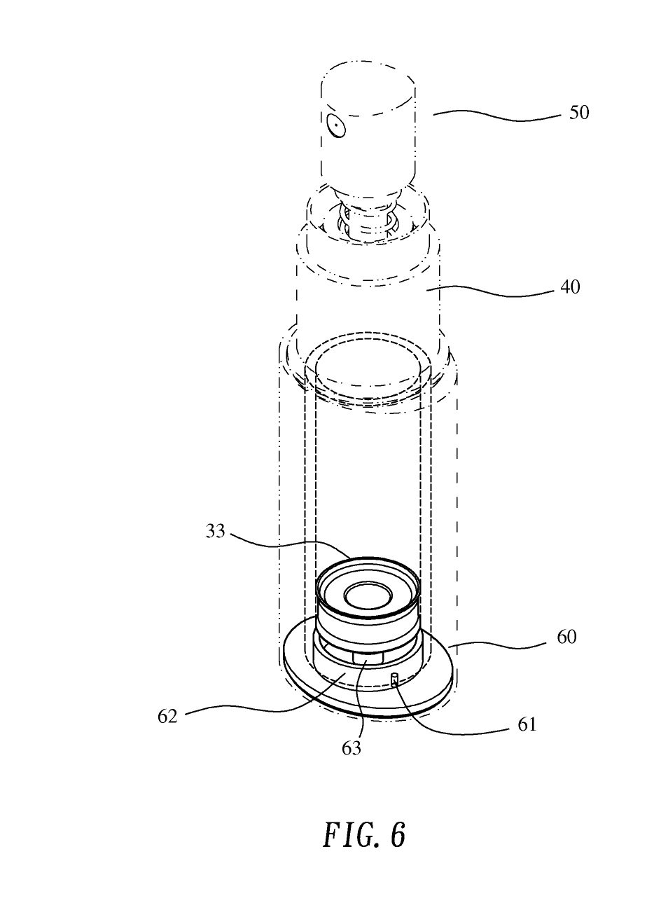

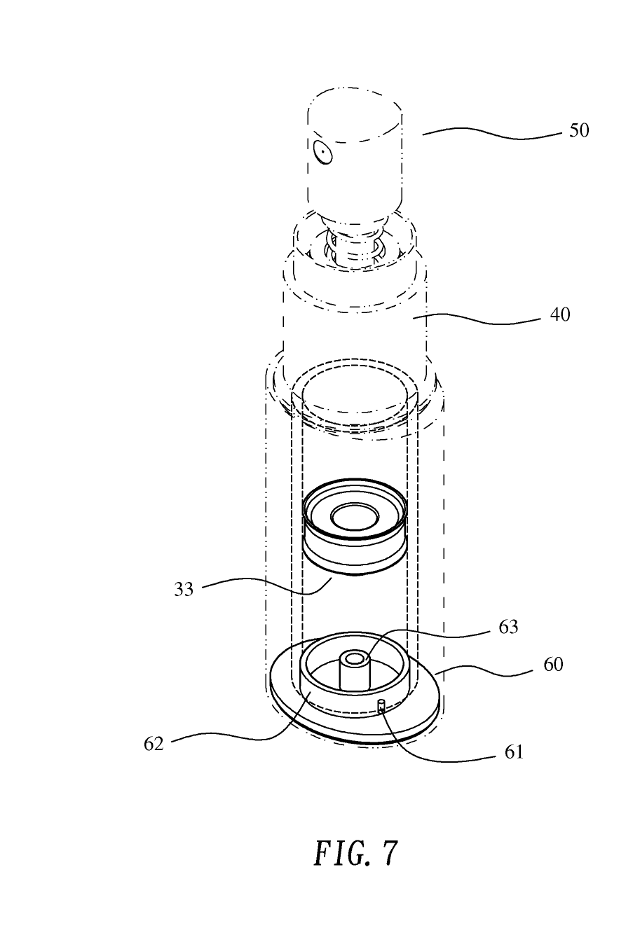

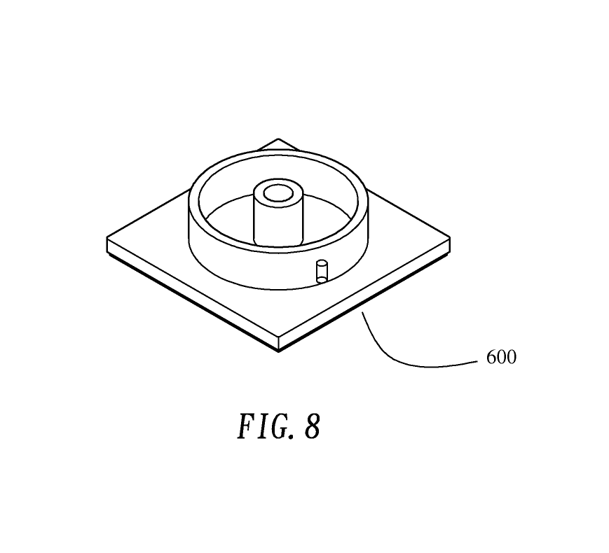

FIGS. 6 and 7 are phantom perspective views showing the follow-up piston 33 at different positions in the cylindrical inner wall 31 of the container 30. In FIG. 6, the follow-up piston 33 is located at a bottommost position in the inner wall 31 before the fluid dispenser head 50 is depressed to dispense a contained fluid (not shown). When the fluid dispenser head 50 is depressed, the follow-up piston 33 is subject to pressure from the external air via the vent hole 61 and moves upward, as shown in FIG. 7, so that the fluid (not shown) contained in the inner space defined in the cylindrical inner wall 31 is smoothly dispensed via a nozzle of the fluid dispenser head 50.

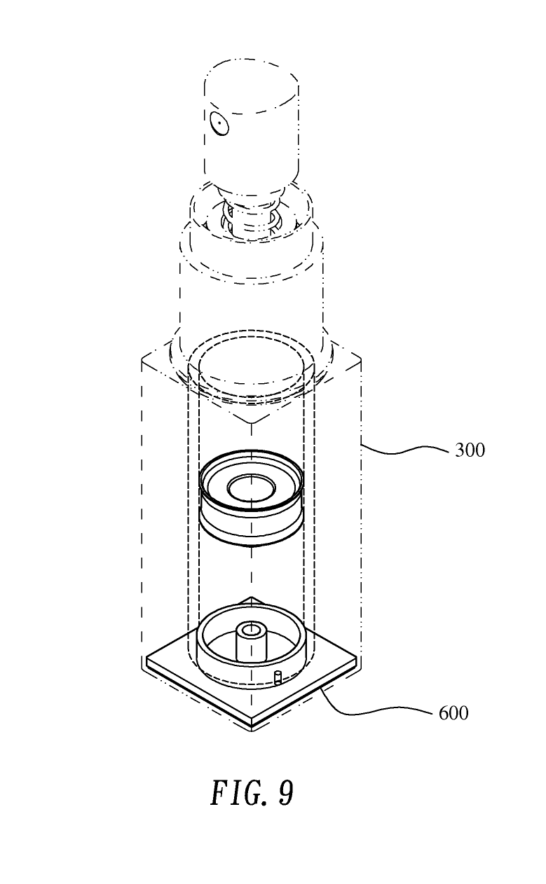

FIG. 8 shows another bottom cover 600 for a free-form container 300 according to another embodiment of the present invention. As can be seen from FIG. 9, the free-form outer wall of the container 300 has a square cross section, and the bottom cover 600 has a matching square cross section to give the whole container 30 a different form.

With the above arrangements, containers with follow-up piston may still have differently designed outward appearances without being limited to a cylindrical shape. Therefore, the container with follow-up piston according to the present invention may have exterior design varied with the fluid contained therein to attract more consumers without adversely affecting the working efficiency of the follow-up piston in the cylindrical inner wall.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A free-form container with follow-up piston, comprising an integrally formed double-wall body defining a specific internal volume for containing a fluid therein; a top cover openably closed to an open upper end of the container; a fluid dispenser head assembled to the open upper end of the container and upward projected from the top cover; and a bottom cover fitted to an open lower end of the container to seal the same; wherein the double-wall body consists of a cylindrical inner wall and a free-form outer wall; the cylindrical inner wall defining a fully round inner wall surface and an open bottom, a follow-up piston being mounted in the round inner wall surface of the cylindrical inner wall to face toward the fluid dispenser head, and the free-form outer wall being integrally formed at an outer side of the cylindrical inner wall; and wherein the bottom cover is provided with a vent hole communicating with an inner space defined in the inner wall.

2. The free-form container with follow-up piston as claimed in claim 1, wherein the cylindrical inner wall is formed near an upper part with a radially outward extended annular shoulder portion, and the free-form outer wall is downward extended from the shoulder portion to define an open bottom; the open bottom of the outer wall and the open bottom of the inner wall together form the open lower end of the container.

3. The free-form container with follow-up piston as claimed in claim 2, wherein the bottom cover has a shape matching a cross section of the open lower end of the container formed by the open bottoms of the inner and outer walls, so as to seal the open lower end of the container; and the vent hole formed on the bottom cover communicating the inner space defined in the inner wall with external air.

4. The free-form container with follow-up piston as claimed in claim 3, wherein the bottom cover is provided on an upper side with a ring portion having a size matching an inner diameter of the inner wall surface of the cylindrical inner wall, and a centered stop ring; the bottom cover being assembled to the open lower end of the container with the ring portion tightly fitted in the inner wall surface of the cylindrical inner wall and the stop ring located corresponding to and below the follow-up piston; and wherein when the bottom cover has been assembled to the container, the air vent communicates the inner space of the inner wall with external environment, and an outer periphery of the bottom cover is abutted against the open bottom of the outer wall in a tight-fit relation.

5. The free-form container with follow-up piston as claimed in claim 1, wherein the free-form outer wall is integrally formed to have a geometrical cross section selected from the group consisting of at least an oval shape, a square shape, and a rectangular shape.

6. The free-form container with follow-up piston as claimed in claim 1, wherein the free-form outer wall is integrally formed to show an ornamental appearance as needed.
